(19) United States
(12) Patent Application Publication
(10) Pub. No.: US 2006/0044381 A1
(43) Pub. Date: Mar. 2, 2006

(54) Printer

(75) Inventor: Chikashi Osakama, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/216,887

(22) Filed: Aug. 26, 2005

(30) Foreign Application Priority Data
Sep. 1, 2004 (JP) 2004-254424

(51) Int. Cl. B41J 2/01

(52) U.S. Cl. 347/104

(57) ABSTRACT

In a printer, a first sensor and a second sensor are disposed, respectively, upstream and downstream of a print head in the feeding direction of a roll of paper. The size of printing media is detected based on the distance between two consecutive detection marks sensed by the first sensor, and leading edges of the printing media sensed by the first sensor are detected by the second sensor.

### BACKGROUND OF THE INVENTION

1. Field of the Invention

The present invention relates to a printer that uses a roll of paper including a plurality of detachable printing media stuck on a carrier sheet. More particularly, the present invention relates to a printer that can use various types of rolls of paper which have differently sized detachable printing media stuck thereon, and that can substantially reduce the time taken to detect a roll of paper and to locate the leading edge of the paper.

2. Description of the Related Art

In known printers, the printing position is detected by sensing detection elements provided on a roll of paper with a sensor.

Japanese Unexamined Patent Application Publication No. 2001-71574 discloses one of these printers that uses a roll of paper including a carrier sheet, and a plurality of stripping sheets serving as printing media separably stuck on the carrier sheet. Each of the stripping sheets is formed, for example, by applying an adhesive material onto a back surface of a single-layer film or a laminate film. Once the stripping sheet is separated from the carrier sheet, it loses adhesiveness on the back surface.

A front surface of the stripping sheet that is not stuck on the carrier sheet is white and unpatterned, and printing thereon is possible.

The carrier sheet has detection marks arranged as position-detecting elements at the pitch corresponding to the pitch of the stripping sheets. The detection marks are provided so that the pitch of the stripping sheets is detected and so that printing is performed on precise positions on the stripping sheets in the printer.

The above-described printer using a roll of paper includes an automatic sheet feeder that automatically feeds sheets stacked in a hopper one by one, a supply roller disposed downstream of the automatic sheet feeder in the sheet feeding direction, and a paper-roll holder disposed behind the automatic sheet feeder.

A feeding roller and an ejection roller are disposed downstream of the supply roller. A platen is interposed between the feeding roller and the ejection roller to support a roll of paper from below during printing.

A print head is mounted at a lower end of a carriage above the platen, and faces downward for scanning.

A sensor is disposed upstream of the feeding roller to sense detection marks on the roll of paper. Every time the sensor senses a detection mark, it transmits a detection signal to a control panel, and the control panel transmits a control signal to the feeding roller so as to advance the paper by a predetermined distance.

In the conventional printer, however, the positions of printing media on the carrier sheet of the roll of paper are detected by sensing detection marks arranged at the pitch corresponding to the pitch of the printing media. Therefore, the printer must use special rolls of paper, but cannot use various types of rolls of paper that have differently sized printing media.

### SUMMARY OF THE INVENTION

Accordingly, it is an object of the present invention to provide a printer that can use various types of rolls of paper which have differently sized detachable printing media stuck thereon, and that can substantially reduce the time taken to detect printing media and to locate leading edges of the printing media.

In order to achieve the above object, the present invention provides a printer that uses a roll of paper including a carrier sheet, a plurality of detachable printing media stuck on the carrier sheet, and detection elements used to detect the positions of the printing media. The printer performs printing on the printing media while detecting the detection elements. The printer includes a print head, a first sensor disposed upstream of the print head in the feeding direction of the roll of paper, and a second sensor disposed downstream of the print head. The size of the printing media is found on the basis of the distance between two consecutive detection elements detected by the first sensor, and the second sensor detects leading edges of the printing media sensed by the first sensor.

In this configuration, a roll of paper loaded in the printer is conveyed in a printing direction, and the first sensor detects the distance between the first and second detection elements provided on the paper. Consequently, the size of detachable printing media stuck on a carrier sheet can be detected. This allows the printer to use various types of rolls of paper that have differently sized printing media.

After the size of the printing media is detected by the first sensor, the roll of paper is advanced or rewound so that the first detection element on the paper reaches a position where it is sensed by the second sensor. When the second sensor senses the first detection element, the leading edge of the paper is located. Consequently, it is possible to substantially reduce the time taken from when the size of the printing media is detected by the first sensor to when the leading edges of the printing media are located by the second sensor.

As described above, the printer of the present invention can use various types of rolls of paper that have differently sized detachable printing media stuck on a carrier sheet, and can substantially reduce the time taken from when the size of the printing media is detected to when the leading edge of the paper is located.

### BRIEF DESCRIPTION OF THE DRAWINGS

FIG. 1 is a schematic view of a printer according to an embodiment of the present invention; and

FIG. 2 is a schematic view of an example of a roll of paper adopted in the embodiment.

### DESCRIPTION OF THE PREFERRED EMBODIMENTS

A printer according to an embodiment of the present invention will be described below with reference to the drawings.

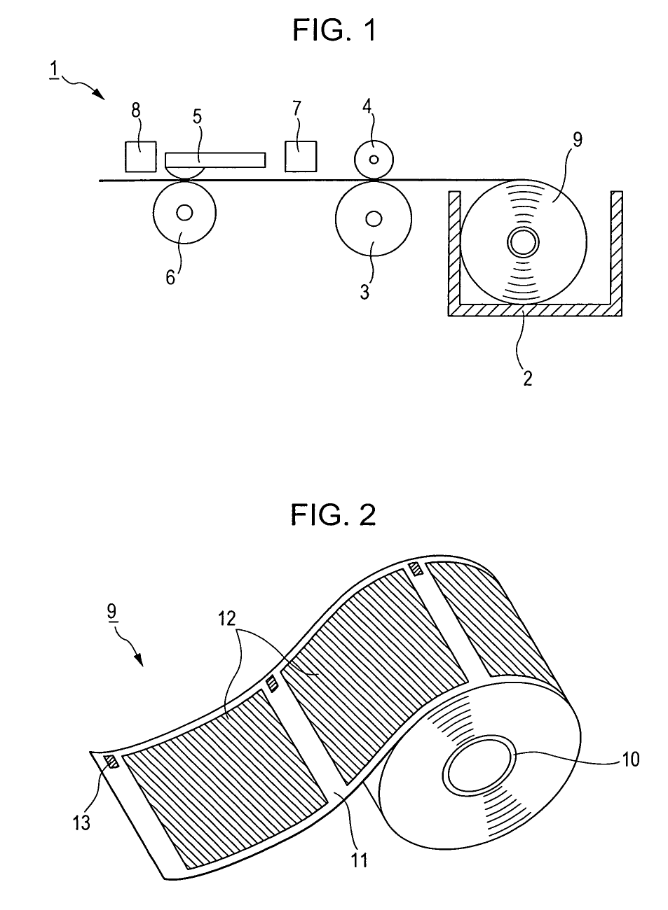

FIG. 1 is a schematic view of a printer according to an embodiment of the present invention, and FIG. 2 is a schematic view of an example of a roll of paper used in the embodiment.

Referring to FIG. 1, a printer 1 according to an embodiment of the present invention includes a paper-roll holder 2 in which a below-described roll of paper 9 is loaded, a feeding roller 3 for drawing the paper 9 out of the paper-roll holder 2, and a pressing roller 4 that is in pressing contact with the feeding roller 3 with a predetermined pressure. A thermal head 5 and a platen roller 6 are disposed downstream of the feeding roller 3 and the pressing roller 4 in the paper feeding direction. The platen roller 6 is in pressing contact with the thermal head 5 with an ink ribbon (not shown) and the paper 9 drawn out of the paper-roll holder 2 disposed therebetween.

The roll of paper 9 used in this embodiment includes a roll core 10 and a long carrier sheet 11 wound therearound, as shown in FIG. 2. A plurality of detachable printing media 12 are stuck at regular intervals on the surface of the carrier sheet 11, and detection marks 13 serving as detection elements are also provided thereon at regular intervals so that the positions of the printing media 12 can be detected.

A first sensor 7 is disposed upstream of the thermal head 5 in the paper feeding direction. The first sensor 7 senses the detection marks 13 provided on the paper 9 so that a controller (not shown) of the printer 1 detects the size of the printing media 12 on the basis of the rotation amount of the feeding roller 3, that is, the feeding amount of the roll of paper 9. A second sensor 8 is disposed downstream of the thermal head 5 in the paper feeding direction. The second sensor 8 senses the detection marks 13 on the paper 9 in order to position the leading edges of the printing media 12 sensed by the first sensor 7. Since a plurality of detachable printing media 12 stuck on one roll of paper 9 have the same size, it is necessary for the first sensor 7 to detect the size of only the first one of the printing media 12.

Each of the first sensor 7 and the second sensor 8 is a reflective photosensor, and includes a light-emitting diode (not shown) serving as a light-emitting element, and a phototransistor (not shown) serving as a photoreceptor for receiving reflected light. When the roll of paper 9 is conveyed by the feeding roller 3 after the printer 1 is started or the paper 9 is loaded, each of the first and second sensors 7 and 8 emits light from the light-emitting diode to each detection element 13 on the paper 9, and receives a predetermined amount of light reflected by the detection marks 13 by the phototransistor, thus detecting the detection marks 13.

The operation of the printer 1 having the above-described configuration will now be described.

First, a roll of paper 9 is loaded in the paper-roll holder 2 of the printer 1. An edge of the paper 9 is nipped between the feeding roller 3 and the pressing roller 4, and the paper 9 is conveyed by the rotation of the feeding roller 3.

Subsequently, the light-emitting element of the first sensor 7 emits light onto the paper 9 conveyed by the feeding roller 3 in order to sense the first and second detection marks 13 on the paper 9. In this case, the controller of the printer 1 detects the size of a detachable printing medium 12 stuck between the first and second detection marks 13 on the basis of the amount of feeding of the paper 9 from when the first detection mark 13 is sensed to when the second detection mark 13 is sensed.

After the size of the printing medium 12 is detected by the first sensor 7, when it is smaller than the distance between the first sensor 7 and the second sensor 8, the feeding roller 3 rotates forward to advance the paper 9. When the first detection mark 13 on the paper 9 is sensed by using light emitted from the light-emitting element of the second sensor 8, the feeding roller 3 stops, and the leading edge of the paper 9 is located. In contrast, when the size of the printing medium 12 is larger than the distance between the first sensor 7 and the second sensor 8, the feeding roller 3 is reversed to feed the roll of paper 9 back. When the first detection mark 13 on the paper 9 is sensed by using light emitted from the light-emitting element of the second sensor 8, the feeding roller 3 stops, and the leading edge of the paper 9 is located.

As described above, in the printer 1 of this embodiment, the size of the detachable printing media 12 can be found by detecting the distance between the detection marks 13 provided on the roll of paper 9 loaded in the paper-roll holder 2. Accordingly, various types of rolls of paper that have differently sized detachable printing media stuck thereon can be used in the printer 1.

By rotating the feeding roller 3 forward or in reverse after the size of the printing media 12 is detected by the first sensor 7, the roll of paper 9 is conveyed to a position where the first detection mark 13 on the paper 9 is sensed by the second sensor 8, thereby locating the leading edge of the paper 9. This substantially reduces the time taken from when the size of the printing media 12 is detected to when the leading edge of the paper 9 is located.

The present invention is not limited to the above-described embodiment, and various modifications are possible, as necessary. For example, while the detection marks 13 are provided as the detection elements on the roll of paper 9 in the embodiment, for example, cutouts may be provided. In a case in which cutouts are provided as the detection elements, the light-emitting element and the photoreceptor in each of the first and second sensors 7 and 8 may be arranged opposed to each other with the paper disposed therebetween so that light emitted from the light-emitting element is received by the photoreceptor through the cutouts.

1. A printer that uses a roll of paper including a long carrier sheet, a plurality of detachable printing media stuck on the carrier sheet, and detection elements used to detect the positions of the printing media, and that performs printing on the printing media while detecting the detection elements,
wherein the printer comprises:
a print head;
a first sensor disposed upstream of the print head in a feeding direction of the roll of paper; and
a second sensor disposed downstream of the print head in the feeding direction, and
wherein a size of the printing media is detected on the basis of a distance between two consecutive detection elements sensed by the first sensor, and leading edges of the printing media sensed by the first sensor are detected by the second sensor.
